(19) United States
(12) Patent Application Publication
(10) Pub. No.: US 2017/0241101 A1
(43) Pub. Date: Aug. 24, 2017

(54) LOADER BUCKET

(71) Applicant: Caterpillar Inc., Peoria, IL (US)

(72) Inventor: David M. Worth, Naperville, IL (US)

(73) Assignee: Caterpillar Inc., Peoria, IL (US)

(21) Appl. No.: 15/050,522

(22) Filed: Feb. 23, 2016

(51) Int. Cl. E02F 3/40; E02F 9/28; F16M 13/02

(52) U.S. Cl. CPC E02F 3/401; E02F 3/40; F16M 13/02; E02F 9/2883

(57) ABSTRACT

A mounting member for coupling a rock guard with a top wall of a loader bucket is provided. The mounting member includes a base plate having a first end and a second end distal to the first end. The base plate is configured to couple to the top wall. The base plate includes a diametric portion at the first end and an elongate portion at the second end. The mounting member also includes an extension plate projecting upwards from the base plate. The extension plate is configured to couple the rock guard with the top wall. The extension plate includes a first inclined edge defined at a first angle with respect to the base plate. The first inclined edge is configured to couple with the rock guard. The extension plate also includes a second inclined edge distal to the first inclined edge.

### TECHNICAL FIELD

The present disclosure relates to a loader bucket, and more particularly relates to a mounting member for coupling a rock guard with a top wall of the loader bucket.

### BACKGROUND

Machines, such as loaders, dozers, excavators, and the like include a work tool for carrying out various operations. An example of such work tool is a loader bucket that includes a rock guard. The rock guard of the loader bucket is subjected to wear during earth moving operations. With prolonged usage of the loader bucket, the rock guard may become weak. This may increase maintenance cost of the loader bucket, and further affect productivity of the machine as maintenance of the loader bucket may increase down time associated with the machine.

U.S. Pat. No. 8,770,908, hereinafter referred to as the '908 patent, describes a support structure for a tilt cylinder of a machine that controls movement of an articulating implement. The support structure may include a mounting plate, vertical support plates extending outwardly from a top surface of the mounting plate, and a central and side gussets connected to the top surface of the mounting plate and to the outer sides of the vertical support plates. The gussets assist in transitioning lateral or horizontal forces on the vertical support plates to the mounting plate and the end frame of the machine to reduce fatigue cracking at the points of connection of the vertical support plates to the mounting plate. The support structure may further include first and second lower support plates having top edges spaced from each other and connected to the bottom surface of the mounting plate, and bottom edges connected to each other so that the lower support plates and the mounting plate form a triangle in cross-section to further assist in transitioning the forces to the end frame. However, the support structure of the '908 patent may increase an overall weight of the implement.

### SUMMARY OF THE DISCLOSURE

In one aspect of the present disclosure, a mounting member for coupling a rock guard with a top wall of a loader bucket is provided. The mounting member includes a base plate having a first end and a second end distal to the first end. The base plate is configured to couple to the top wall. The base plate includes a diametric portion at the first end. The base plate also includes an elongate portion at the second end. The elongate portion extends from the diametric portion. The mounting member also includes an extension plate projecting upwards from the base plate. The extension plate is configured to couple the rock guard with the top wall. The extension plate includes a first inclined edge defined at a first angle with respect to the base plate. The first inclined edge is configured to couple with the rock guard. The extension plate also includes a second inclined edge distal to the first inclined edge. The second inclined edge is defined at a second angle with respect to the base plate.

In another aspect of the present disclosure, a loader bucket is provided. The loader bucket includes a bottom wall having a cutting edge assembly. The loader bucket also includes a pair of side walls coupled to the bottom wall. Further, the bottom wall and the pair of side walls are together configured to carry a material. The loader bucket further includes a mounting member for coupling a rock guard with a top wall of the loader bucket. The mounting member includes a base plate having a first end and a second end distal to the first end. The base plate is configured to couple to the top wall. The base plate also includes a diametric portion at the first end and an elongate portion at the second end. The elongate portion extends from the diametric portion. The mounting member further includes an extension plate that projects upwards from the base plate. The extension plate is configured to couple the rock guard with the top wall. The extension plate includes a first inclined edge defined at a first angle with respect to the base plate. The first inclined edge is configured to couple with the rock guard. The extension plate also includes a second inclined edge distal to the first inclined edge that is defined at a second angle with respect to the base plate.

In yet another aspect of the present disclosure, a loader bucket is provided. The loader bucket includes a bottom wall having a cutting edge assembly. The loader bucket also includes a pair of side walls coupled to the bottom wall. The loader bucket further includes a top wall extending from the bottom wall, and between each of the pair of side walls. Further, the bottom wall, the top wall, and the pair of side walls are together configured to carry a material. The loader bucket includes a rock guard coupled to the top wall. The loader bucket also includes a mounting member configured to reinforce coupling of the rock guard with the top wall. The mounting member includes a base plate having a first end and a second end distal to the first end. The base plate is configured to couple to the top wall. The base plate includes a diametric portion at the first end. The base plate also includes an elongate portion at the second end that extends from the diametric portion. The mounting member also includes an extension plate projecting upwards from the base plate. The extension plate is configured to couple the rock guard with the top wall. The extension plate includes a first inclined edge defined at a first angle with respect to the base plate. The first inclined edge is configured to couple with the rock guard. The extension plate also includes a second inclined edge distal to the first inclined edge. Further, the second inclined edge is defined at a second angle with respect to the base plate.

Other features and aspects of this disclosure will be apparent from the following description and the accompanying drawings.

### BRIEF DESCRIPTION OF THE DRAWINGS

FIG. 1 is a perspective view of a loader bucket and a rock guard disposed on a top wall of the loader bucket, according to an embodiment of the present disclosure;

FIG. 2 is a perspective view showing coupling of the rock guard with the top wall by a mounting member, according to an embodiment of the present disclosure;

FIG. 3 is a perspective view of the mounting member coupled to the top wall of the loader bucket, according to an embodiment of the present disclosure;

FIG. 4 is a side view of the mounting member coupled to the top wall of the loader bucket, according to an embodiment of the present disclosure; and

FIG. 5 is a top view of the mounting member coupled to the top wall of the loader bucket, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

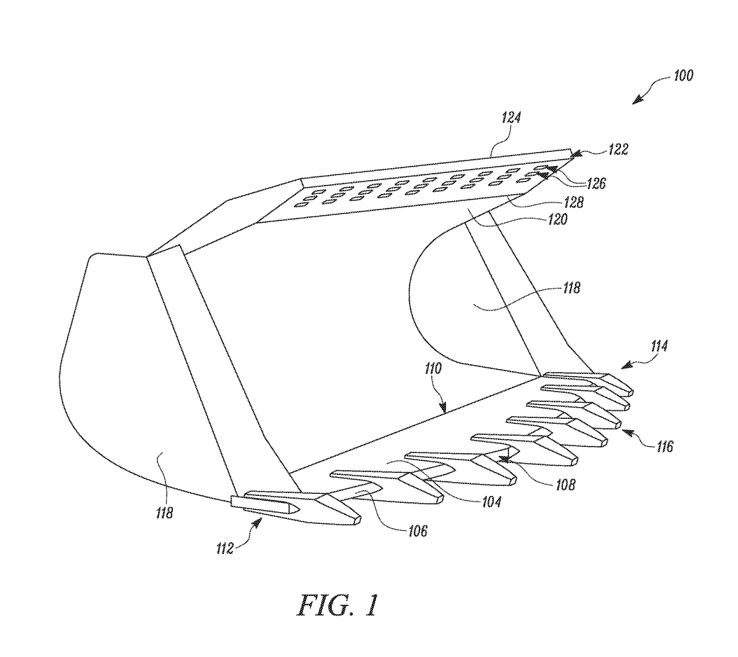

FIG. 1 illustrates a perspective view of a loader bucket 100. In the illustrated embodiment, the loader bucket 100 may be associated with a machine (not shown), such as, a wheel loader or a track loader. The machine may embody a wheeled machine or a tracked machine, based on operational requirements. In various embodiments, a work tool, such as, the loader bucket 100 may be associated with various machines, including, but not limited to, a dozer, an excavator, or any other machine used for excavation, digging, etc. The loader bucket 100 may be used for performing earth moving operations, such as for excavation, and for loading and unloading earthen material. The loader bucket 100 may be pivotally attached to a frame of the machine adjacent to a front end and/or a rear end thereof.

The loader bucket 100 includes a bottom wall 104 having a cutting edge 106. The bottom wall 104 includes a leading end 108 and a trailing end 110 extending between a first end 112 and a second end 114 of the bottom wall 104. A number of teeth 116 are attached to the cutting edge 106 of the bottom wall 104. The number of teeth 116 engages with a work surface for performing excavation operation.

The loader bucket 100 further includes a pair of side walls 118 coupled to the bottom wall 104. Each of the pair of side walls 118 is disposed at the first and second ends 112, 114 of the bottom wall 104. The loader bucket 100 further includes a top wall 120 extending from the trailing end 110 of the bottom wall 104 and between the pair of side walls 118. The bottom wall 104, the pair of side walls 118 and the top wall 120 together carries the earthen material.

The loader bucket 100 includes a rock guard 122. The rock guard 122 extends away from the top wall 120 such that it covers excess amount of the earthen material carried within the loader bucket 100. Further, the rock guard 122 deflects any undesirable materials, such as heavy rocks and other hard materials from the loader bucket 100 while carrying out operations, such as excavation, quarrying, and the like.

The rock guard 122 is coupled to the top wall 120 by a coupling method, such as welding. The rock guard 122 may have a length extending along the top wall 120 and extends between the first and second ends 112, 114. A width of the rock guard 122 may extend away from the top wall 120 such that the operator's line of sight is unobstructed. The rock guard 122 includes a rock guard edge 124 that extends away from the top wall 120. Further, the rock guard 122 is coupled to the top wall 120 at a predefined angle. The predefined angle is decided such that optimum stress is developed between the top wall 120 and the rock guard 122 when the machine is in operation.

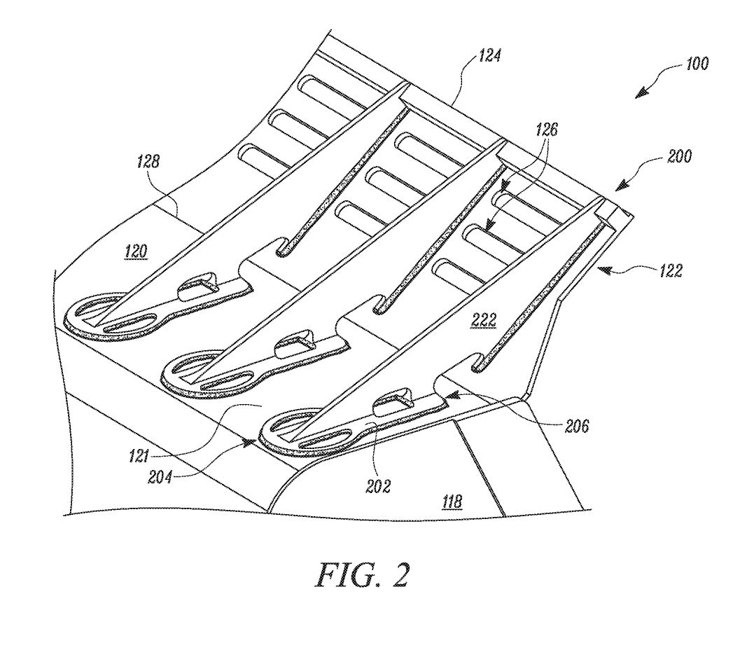

FIG. 2 is a perspective view illustrating coupling of the rock guard 122 with the top wall 120 by a mounting member 200, according to an embodiment of the present disclosure. In the illustrated embodiment, the rock guard 122 is made from a sheet of metal having multiple grooves 126 along the length of the rock guard 122. Alternately, the rock guard 122 may be made from hollow pipes, steel rods or thin plates, which may be arranged parallel to the top wall 120 to define the width of the rock guard 122. In one example, the rock guard 122 may be made of abrasion resistant steel, without limiting the scope of the present disclosure.

In the illustrated embodiment, the rock guard 122 is welded to the top wall 120. In another embodiment, the rock guard 122 may be coupled to the top wall 120 along an edge 128 by one or more fastening members including, but not limited to, screws, bolts, rivets, or by any other fastening members known in the art. The rock guard 122 is reinforced to the top wall 120 by the mounting member 200. As shown in FIG. 2, a number of mounting members 200 reinforce the rock guard 122 with the top wall 120. For explanatory purposes, a single mounting member 200 will now be explained in detail. However, it should be noted that the description provided below is applicable to all the mounting members 200 of the loader bucket 100.

The mounting member 200 includes a base plate 202 and an extension plate 222 extending from the base plate 202. The base plate 202 is coupled to an upper surface 121 of the top wall 120. The base plate 202 is designed in such a way to increase an area of contact of the base plate 202 with the upper surface 121 of the top wall 120. The extension plate 222 is coupled to the rock guard 122. The extension plate 222 prevents twisting or bending of the rock guard 122 when the loader bucket 100 is in operation. The extension plate 222 of the mounting member 200 is placed between adjacent sets of grooves 126 of the rock guard 122. The mounting member 200 may be made from variety of materials including, but not limited to, alloy steel or any other materials known in the art.

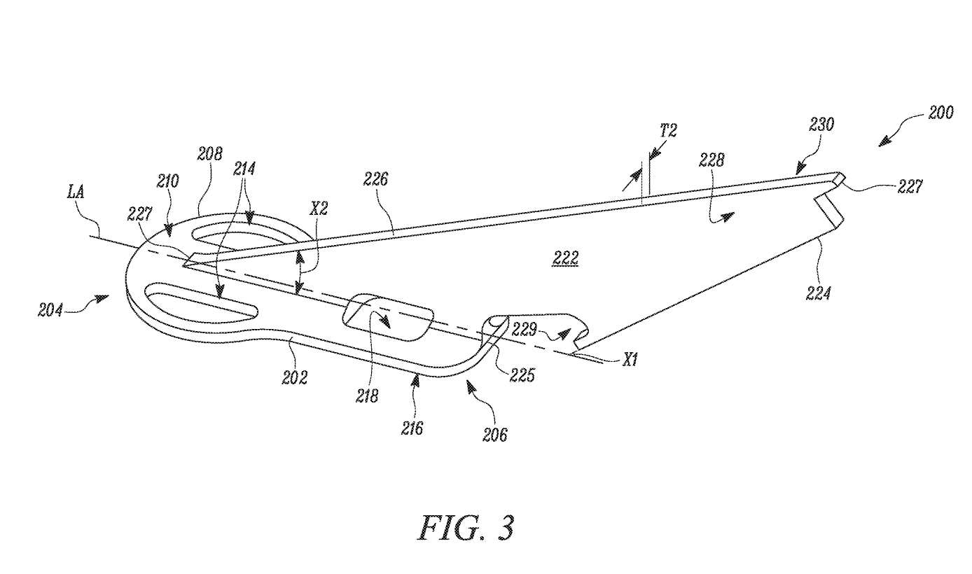

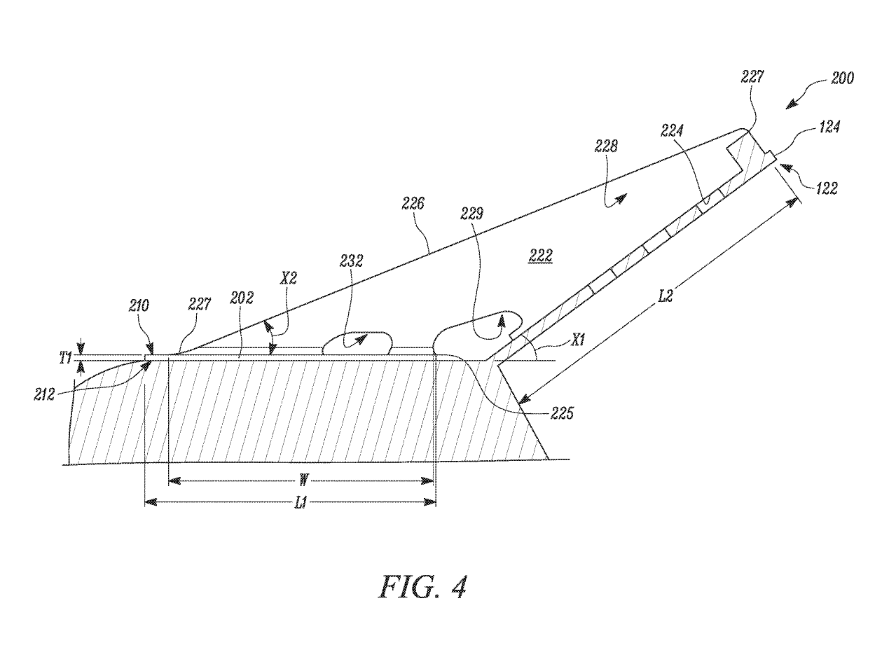

FIG. 3 illustrates a perspective view of the mounting member 200, according to an embodiment of the present disclosure. The base plate 202 includes a first end 204 and a second end 206 distal to the first end 204. The base plate 202 further includes a top surface 210 and a bottom surface 212 (shown in FIG. 4) distal to the top surface 210. The bottom surface 212 abuts the upper surface 121 of the top wall 120 (see FIG. 2). Further, the base plate 202 has a first thickness “T1” (shown in FIG. 4) defined between the bottom surface 212 and the top surface 210 thereof.

The base plate 202 further includes a diametric portion 208 at the first end 204. In the illustrated embodiment, the diametric portion 208 is circular in shape such that it increases surface area of the base plate 202. The diametric portion 208 includes at least a first cutout 214 that extends between the top surface 210 and the bottom surface 212. In the illustrated embodiment, the diametric portion 208 includes a pair of the first cutouts 214. The pair of the first cutouts 214 is semi-circular in shape. The pair of the first cutouts 214 receives a welding material therein.

In an alternate embodiment, the diametric portion 208 of the base plate 202 may have any other geometric shapes including, but not limited to, triangular, square, oval, or polygonal. Further, the diametric portion 208 may have a number of the first cutouts 214. The first cutout 214 may have a circular, rectangular, square, polygonal, or any other shape to receive optimum welding material therein in order to increase the area of contact of the base plate 202 with the upper surface 121 of the top wall 120.

The base plate 202 includes an elongate portion 216. The elongate portion 216 extends from the diametric portion 208 to the second end 206. The elongate portion 216 includes at least a second cutout 218 extending between the top surface 210 and the bottom surface 212. The second cutout 218 receives a welding material therein. The mounting member 200 further includes the extension plate 222 that projects upwards from the diametric portion 208 and the elongate portion 216 of the base plate 202. The extension plate 222 extends vertically from the base plate 202 along a longitudinal axis ‘LA’ defined by the base plate 202. In the illustrated embodiment, the mounting member 200 is fabricated from a metal plate, in which the extension plate 222 is welded to the base plate 202. In other embodiments, the mounting member 200 having the base plate 202 and the extension plate 222 may be manufactured as a single component using a manufacturing processes including, but not limited to, casting, injection molding, or any other manufacturing processes known in the art.

The extension plate 222 includes a first side surface 228 and a second side surface 230 opposite to the first side surface 228. The extension plate 222 has a second thickness “T2” defined between the first side surface 228 and the second side surface 230. Referring to FIGS. 3 and 4, the extension plate 222 includes a bottom width “W” defined between the first and second ends 204, 206 of the base plate 202. In an example, the bottom width “W” may be less than or equal to a length “L1” of the base plate 202. In the present embodiment, a bottom of the extension plate 222 includes a void 232. The void 232 is provided over the second cutout 218 in the base plate 202 (as shown in FIG. 3). The void 232 extends between the first side surface 228 and the second side surface 230. The void 232 may allow welding of the base plate 202 with the upper surface 121 of the top wall 120 at the second cutout 218.

The extension plate 222 includes a first inclined edge 224 that is defined at a first angle “X1” with reference to the base plate 202. The first inclined edge 224 is configured to couple with the rock guard 122. The first inclined edge 224 defines a first intersection 225 at the second end 206 of the base plate 202, as shown. The extension plate 222 also includes a second inclined edge 226 that is defined at a second angle “X2” with reference to the base plate 202. Further, the first inclined edge 224 and the second inclined edge 226 converge to define a second intersection 227, as shown. In an example, the first angle “X1′ between the first inclined edge 224 and the base plate 202 is in a range between 120 degrees to 160 degrees. Further, the second angle “X2” between the second inclined edge 226 and the base plate 202 is in a range between 20 degrees to 40 degrees.

In the present embodiment, the extension plate 222 includes a third cutout 229 at the first intersection 225. In an alternate embodiment, the extension plate 222 may include multiple cutouts. The third cutout 229 extends between the first and second side surfaces 228, 230. The extension plate 222 has a length “L2” (shown in FIG. 4) defined between the first intersection 225 and the second intersection 227. In an example, a ratio of the length “L2” of the extension plate 222 and the length “L1” of the base plate 202 is in a range between 1 to 2.5.

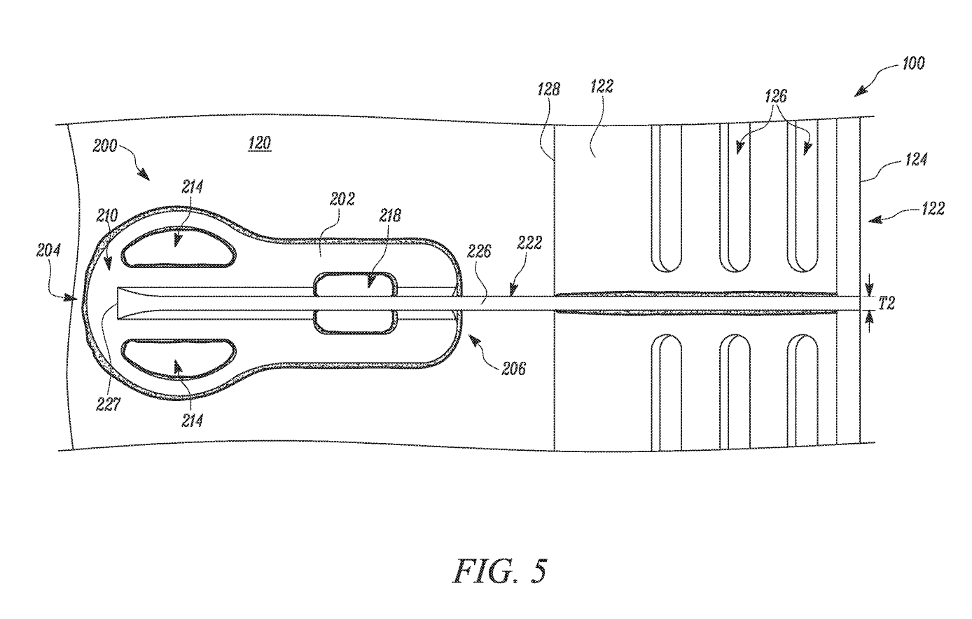

FIGS. 4 and 5 illustrate a side view and a top view of the mounting member 200, according to the embodiment of the present disclosure. The base plate 202 is further welded at the first and second cutouts 214, 218. The base plate 202 of the mounting member 200 is welded to the upper surface 121. As shown in FIGS. 2 and 5, the base plate 202 is welded at the first and second cutouts 214, 218. Alternatively, apart from welding, the base plate 202 may be coupled to the upper surface 121 using any other fastening means known in the art. Further, the extension plate 222 of the mounting member 200 is welded to the rock guard 122. Alternatively, the extension plate 222 may be coupled to the rock guard 122 using any other fastening means known in the art.

### INDUSTRIAL APPLICABILITY

The present disclosure relates to the mounting member 200 for reinforcing coupling of the rock guard 122 with the loader bucket 100. The mounting member 200 includes the base plate 202 and the extension plate 222. In one example, the mounting member 200 is manufactured using the casting process. The casting design of the base plate 202 and the extension plate 222 enables smooth transition of load between the rock guard 122 and the top wall 120. The base plate 202 includes the diametric portion 208 and the elongate portion 216 that are welded to the upper surface 121 of the top wall 120.

Further, the diametric and elongate portions 208, 216 include the first and second cutouts 214, 218, respectively. The first and second cutouts 214, 218 increase the welding area, thereby increasing durability of the mounting member 200. The first and second cutouts 214, 218 also help in reducing weight of the mounting member 200 and welding stresses. The extension plate 222 is welded to the rock guard 122 having the third cutout 229 transfers the impact loads from the rock guard 122 to the loader bucket 100 efficiently. Further, the third cutout 229 also helps to resist buckling of the extension plate 222.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting member for coupling a rock guard with a top wall of a loader bucket, the mounting member comprising:
a base plate having a first end and a second end distal to the first end, the base plate configured to couple to the top wall, the base plate comprising;
a diametric portion at the first end; and
an elongate portion at the second end, and extending from the diametric portion; and
an extension plate projecting upwards from the base plate, and configured to couple the rock guard with the top wall, the extension plate comprising:
a first inclined edge defined at a first angle with respect to the base plate, and configured to couple with the rock guard; and
a second inclined edge distal to the first inclined edge, and defined at a second angle with respect to the base plate.

2. The mounting member of claim 1, wherein the base plate has a first thickness defined between a bottom surface and a top surface thereof, and wherein the bottom surface is configured to abut an upper surface of the top wall of the loader bucket.

3. The mounting member of claim 2, wherein the diametric portion of the base plate comprises at least a first cutout extending between the top surface and the bottom surface, and wherein the first cutout is configured to receive a welding material therein, and to reinforce welding of the base plate with the upper surface of the top wall.

4. The mounting member of claim 2, wherein the elongate portion of the base plate comprises at least a second cutout extending between the top surface and the bottom surface, and wherein the second cutout is configured to receive a welding material therein, and to reinforce welding of the base plate with the upper surface of the top wall.

5. The mounting member of claim 1, wherein the extension plate has a second thickness defined between a first side surface and a second side surface thereof.

6. The mounting member of claim 5, wherein the extension plate comprises at least a third cutout at a first intersection defined by the second end of the base plate and the first inclined edge of the extension plate, and wherein the third cutout extends between the first side surface and the second side surface.

7. The mounting member of claim 6, wherein the extension plate has a length defined between the first intersection and a second intersection defined by the first inclined edge and the second inclined edge.

8. The mounting member of claim 1, wherein the extension plate has a bottom width extending between the first end and the second end of the base plate, and wherein the bottom width of the extension plate is less than or equal to a length of the base plate.

9. The mounting member of claim 1, wherein a ratio of a length of the extension plate and a length of the base plate is in a ratio between 1.0 and 2.5.

10. The mounting member of claim 1, wherein the first angle is in a range between 120 degrees and 160 degrees.

11. The mounting member of claim 1, wherein the second angle is in a range between 20 degrees and 40 degrees.

12. A loader bucket comprising:
a bottom wall having a cutting edge assembly;
a pair of side walls coupled to the bottom wall, wherein the bottom wall and the pair of side walls are together configured to carry a material; and
a mounting member for coupling a rock guard with a top wall of the loader bucket, the mounting member comprising:
a base plate having a first end and a second end distal to the first end, the base plate configured to couple to the top wall, the base plate comprising:
a diametric portion at the first end; and
an elongate portion at the second end, and extending from the diametric portion; and
an extension plate projecting upwards from the base plate, and configured to couple the rock guard with the top wall, the extension plate comprising:
a first inclined edge defined at a first angle with respect to the base plate, and configured to couple with the rock guard; and
a second inclined edge distal to the first inclined edge, and defined at a second angle with respect to the base plate.

13. The loader bucket of claim 12, wherein the base plate has a first thickness defined between a bottom surface and a top surface thereof, and wherein the bottom surface is configured to abut an upper surface of the top wall of the loader bucket.

14. The loader bucket of claim 13, wherein the diametric portion of the base plate comprises at least a first cutout extending between the top surface and the bottom surface, and wherein the first cutout is configured to receive a welding material therein, and to reinforce welding of the base plate with the upper surface of the top wall.

15. The loader bucket of claim 13, wherein the elongate portion of the base plate comprises at least a second cutout extending between the top surface and the bottom surface, and wherein the second cutout is configured to receive a welding material therein, and to reinforce welding of the base plate with the upper surface of the top wall.

16. The loader bucket of claim 12, wherein the extension plate has a second thickness defined between a first side surface and a second side surface thereof.

17. The loader bucket of claim 16, wherein the extension plate comprises at least a third cutout at a first intersection defined by the second end of the base plate and the first inclined edge of the extension plate, and wherein the third cutout extends between the first side surface and the second side surface.

18. The loader bucket of claim 17, wherein the extension plate has a length defined between the first intersection and a second intersection defined by the first inclined edge and the second inclined edge.

19. The loader bucket of claim 12, wherein the extension plate has a bottom width extending between the first end and the second end of the base plate, and wherein the bottom width of the extension plate is less than or equal to a length of the base plate.

20. A loader bucket comprising:
a bottom wall having a cutting edge assembly;
a pair of side walls coupled to the bottom wall;
a top wall extending from the bottom wall, and between each of the pair of side walls, wherein the bottom wall, the top wall, and the pair of side walls are together configured to carry a material;
a rock guard coupled to the top wall; and
a mounting member configured to reinforce coupling of the rock guard with the top wall, the mounting member comprising:
a base plate having a first end and a second end distal to the first end, the base plate configured to couple to the top wall, the base plate comprising:
a diametric portion at the first end; and
an elongate portion at the second end, and extending from the diametric portion; and
an extension plate projecting upwards from the base plate, and configured to couple the rock guard with the top wall, the extension plate comprising:
a first inclined edge defined at a first angle with respect to the base plate, and configured to couple with the rock guard; and
a second inclined edge distal to the first inclined edge, and defined at a second angle with respect to the base plate.
